(19) United States
(12) Patent Application Publication
(10) Pub. No.: US 2024/0266545 A1
(43) Pub. Date: Aug. 8, 2024

(54) Lithium sulfur battery additive

(71) Applicant: Gelion Technologies Pty Ltd., North Sydney (AU)

(72) Inventors: Thomas Maschmeyer, Sydney (AU); Jacob Carpenter, Sydney (AU)

(21) Appl. No.: 18/574,951

(22) PCT Filed: Jul. 5, 2022
(86) PCT No.: PCT/AU2022/050696

§ 371 Date: Dec. 28, 2023

(30) Foreign Application Priority Data
Jul. 5, 2021 (AU) 2021902031

(51) Int. Cl. H01M 4/62; H01M 4/02; H01M 4/13; H01M 10/052

(52) U.S. Cl. CPC H01M 4/628; H01M 4/13; H01M 4/623; H01M 10/052; H01M 2004/021; H01M 2004/028

(57) ABSTRACT

The present invention is directed to a cathode material for a lithium sulfur battery comprising a source of sulfur and a particle having a surface adapted to immobilise a poly sulfide. The surface adapted to immobilise a polysulfide may comprise surface functionalisation with sulfur-containing functional groups, thereby to immobilise the polysulfide. The particle may comprise an internal surface, an external surface, or both, wherein the internal surface and/or the external surface may be functionalised with a plurality of sulfur-containing functional groups.

### FIELD

The present invention relates to the field of energy storage, particularly lithium sulfur batteries. However, it will be appreciated that the invention is not limited to this particular field of use.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Lithium sulfur batteries are a promising battery architecture due to the high charge capacity, energy density, and natural abundance of sulfur. However, they remain in the research stage of development.

The electrodes in lithium-sulfur batteries typically consist of a lithium metal anode and a carbon-sulfur cathode. Sulfur is an insulator and thus must be supported by a conductive framework in order to facilitate conduction to an external load. During discharge, lithium is oxidised at the anode and lithium ions move through the electrolyte and attack the S—S bonds in cyclic S₈ sulfur, initiating the reduction process and producing S₈²⁻ anions with Li⁺ counterions. These polysulfide anions are soluble in the electrolyte, representing a solid-liquid phase transition. Long chain polysulfides are then sequentially reduced until the final stage of sulfur reduction, in which lithium sulfide (Li₂S) is formed and deposited on the cathode. Upon charging this process occurs in reverse with the final step being lithium reduction and redeposition on the anode.

Despite the attractive theoretical performance of lithium sulfur batteries, it has been difficult to achieve satisfactory performance in real world applications. For example, the only known market ready lithium sulfur battery at present (OXIS Energy, UK) has an energy density of 400 Wh/kg, and an expected lifetime of only 60 to 100 cycles. This is due to complications underlying the lithium-sulfur redox chemistry.

### Polysulfide Shuttling

Cleavage of S—S bonds in elemental sulfur by lithium ions leads to the generation of lithium polysulfides: contact ion-pairs consisting of two positive lithium ions at each end of a polysulfide chain which dissociate in the electrolyte. Due to disproportionation reactions, there exists a mixture of anionic and radical polysulfide species of varying chain lengths at any one time in solution. These polysulfides are highly nucleophilic. The complex interactions between the polysulfides themselves in addition to their interaction with materials encountered within the battery architecture has made them a challenging aspect of the Li—S battery chemistry.

Perhaps most problematic is the migration of polysulfide species to the lithium metal anode, where chemical reduction causes the precipitation of insulating species Li₂S₂ and Li₂S. Deposition of these insoluble salts at the lithium anode leads to irreversible active sulfur loss, impeded ion-transfer and formation of dendrites, which can cause short-circuits, self-discharge, and cell failure.

A phenomenon known as the “shuttle effect” is another key challenge in the commercialisation of lithium sulfur cells. During charging, soluble long chain polysulfides migrate to the lithium anode and become chemically reduced to short chain species. These short chain polysulfides then migrate to the cathode where they are again oxidised to their longer chain counterparts, thus creating a parasitic shuttle current that works against the applied charging current (FIG. 1). This self-discharging mechanism leads to poor columbic efficiency in addition to causing corrosion of the lithium metal anode and formation of an unstable solid-electrolyte interface.

The use of surface functionalised carbon additives in the cathode have had a positive effect on the cycle life of lithium sulfur cells, helping to keep polysulfide anions localised by restricting their ability to diffuse throughout the electrolyte. Lithium bonding via groups such as pyridinic nitrogens or other lithiophilic groups (attached to substrates such as carbon nanotubes) restricts lithium polysulfide dissociation and the subsequent diffusion of daughter species. Other techniques have included using porous carbons to physically trap polysulfide species and limit diffusion.

Many electrode modification methods improve longevity, though do not alleviate the issue of polysulfide shuttling and require expensive materials, diminishing one of the lithium sulfur chemistry's key advantages over Li-ion intercalation technology. For example, mesoporous silica has been used as an additive for polysulfide management in sulfur cathodes. It has been shown chemisorption of polysulfide species using amine functionalised silica resulting in increased specific discharge capacity values over cycles compared with additive free cells. Mesoporous silica and titania additives with pore sizes of 5-10 nm have also been used to physically adsorb polysulfides from solution and decrease the concentration gradient, thereby lowering shuttle currents and leading to better capacity retention. However, these existing approaches have limitations such as time-consuming synthesis requiring the use of toxic chemicals, a weak interaction between the surface of the additive and polysulfides, the formation of glassy Li₂S₂ and Li₂S on the exterior of carbon particles leading to rapidly fading discharge capacity, and an increase in overpotential after extended cycling.

In view of the deficiencies of existing lithium sulfur battery technologies, provided herein is an electrode additive for lithium sulfur cells may reduce polysulfide shuttling, thus facilitating a high initial specific charge capacity that is retained after extended cycling, optionally without compromising on the applicable current densities (C-rates).

### SUMMARY OF INVENTION

In a first aspect of the invention, there is provided a cathode material for a lithium sulfur battery comprising a source of sulfur, and a particle having a surface adapted to immobilize a polysulfide.

The following options may be used in conjunction with the first aspect of the invention, either individually or in any combination.

The surface adapted to immobilise a polysulfide may comprise surface functionalisation with sulfur-containing functional groups, thereby to immobilise the polysulfide. The particle may comprise an internal surface, an external surface, or both. The internal surface may be functionalised with a plurality of sulfur-containing functional groups and the external surface may be substantially free from sulfur-containing functional groups. Alternatively, the external surface may be functionalised with a plurality of sulfur-containing functional groups and the internal surface may be substantially free from sulfur-containing functional groups. Alternatively, both the external surface and the internal surface may be functionalised with a plurality of sulfur-containing functional groups. It will be appreciated by the person skilled in the art that a “polysulfide” contains two or more atoms of sulfur in the molecule.

The sulfur-containing functional group may be selected from the group consisting of thiol, thioketone, thial, thiocarboxylic acid, dithiocarboxylic acid, sulfonamide, sulfonate, thiosulfonate, sulfone, and xanthate.

The sulfur-containing functional groups may be covalently joined to the internal or external surface of the particle directly or may be joined by a linker. When the sulfur-containing functional groups are covalently joined to the internal or external surface of the particle by a linker, the linker may be a linear or branched C₁ to C₃₂ alkyl chain, C₁ to C₃₂ alkenyl chain, or C₁ to C₃₂ alkaryl chain, wherein the linker may be optionally substituted.

The particle may be porous. The pore volume of the porous particle may be at least 0.3 cm³/g. The Brunauer-Emmett-Teller surface area of the porous particle may be at least 70 m²/g. The average pore diameter of the porous particle may be between 0.1 nm-5 μm. The degree of functionalisation of the porous particle with the sulfur-containing functional groups may be between 0.1 to 3 mmol/g. The diameter of the porous particle may be between 5 nm-500 μm.

The particle may be substantially spherical and have an internal cavity. In this case, the particle may have a wall thickness of between about 1-500 nm and the diameter of the internal cavity may be between about 1 nm-100 μm.

The source of sulfur may be selected from the group consisting of elemental sulfur, lithium (poly)sulfide, and a sulfur containing composite. The source of sulfur may be encapsulated within the particle.

The cathode material may further comprise a binder. The binder may be selected from the group consisting of fluorinated polymers, optionally poly(vinylidene fluoride) (PVDF), poly(vinylidene fluoride)-co-hexafluoropropylene (PVDF-HFP) or polytetrafluoroethylene (PTFE), cellulose derivatives, optionally CMC, polyacrylic nitrides, polyacrylic acids, co-acrylic acids, styrene butadiene, and ionic polymers.

The particle may be composed of a non-conductive material, and in this case the cathode material further comprises a conductive material. Where the particle is composed of a non-conductive material, the particle may be composed of silica, titania, zeolite, aluminosilicate, or aluminosilica.

In this case, the conductive material may be selected from the group consisting of carbon black, carbon nanotubes, mesoporous carbon, graphene, graphite, expanded graphite, graphene oxides, activated carbons, glassy carbons, and diamond-like carbons.

In this case, the amounts of the conductive material, the source of sulfur, a plurality of the particles, and optionally a binder sum to 100 wt. %, and the amount of conductive material may be between about 3 to 70 wt. %, the amount of the source of sulfur may be between about 20 to 90 wt. %, the amount of particles may be between about 1 to 70 wt. %, and the amount of binder, if optionally present, may be between about 0.1 to 20 wt. %.

Alternatively, the particle may be composed of a conductive material. Where the particle is composed of a conductive material, the particle may be composed of carbon, or transition metal oxides or nitrides, optionally vanadium, zirconium or titanium nitride.

In this case, the cathode material may optionally comprise a further conductive material. The further conductive material may be selected from the group consisting of carbon black, carbon nanotubes, mesoporous carbon, graphene, graphite, expanded graphite, graphene oxides, activated carbons, glassy carbons, and diamond-like carbons.

In this case, the amounts of the source of sulfur, a plurality of the particles, optionally the further conductive material, and optionally a binder sum to 100 wt. %, and the amount of source of sulfur may be between about 20 to 90 wt. %, the amount of porous particles may be between about 1 to 70 wt. %, the amount of further conductive material, if optionally present, may be between about 1 to 30 wt. %, and the amount of binder, if optionally present, may be between about 0.1 to 20 wt. %.

In a second aspect of the invention, there is provided a lithium sulfur battery comprising a cathode comprising the cathode material of the first aspect of the invention, an anode comprising a lithium source, and an electrolyte disposed between the cathode and the anode.

The following options may be used in conjunction with the second aspect of the invention, either individually or in any combination.

The lithium source may be lithium metal, lithiated silicon, or lithiated carbon.

The battery may have a Coulombic efficiency of at least 70% after 100 cycles. The specific discharge capacity of the battery may not decrease by more 20% of its initial value after 100 cycles.

In a third aspect of the invention, there is provided use of a particle in the cathode of a lithium sulfur battery, wherein the particle has a surface adapted to immobilise a polysulfide. The particle may comprise an internal surface, an external surface, or both, wherein the internal surface and/or the external surface may be functionalised with a plurality of sulfur-containing functional groups.

In a fourth aspect of the invention, there is provided a method of reducing capacity fading of a lithium sulfur battery, the battery comprising a cathode comprising a source of sulfur, an anode comprising a lithium source, and an electrolyte, the method comprising adding a particle to the cathode, wherein the particle has an internal surface and an external surface, wherein the internal surface and/or external surface is functionalised with a plurality of sulfur-containing functional groups.

In the third and fourth aspects, the particle may be porous.

### BRIEF DESCRIPTION OF DRAWINGS

FIG. 1. Li—S battery schematic showing the diffusion of polysulfide diffusion during charging and subsequent reduction at the anode, causing a parasitic shuttle current.

FIG. 2. Schematic of cross-sections of different types of porous particles. (a) porous particles in the form of hollow spheres having pores in their spherical external wall. (b) Porous particles in the form of a solid shape having a plurality of channels.

FIG. 3. Specific discharge capacity over 200 cycles for HS—SiO₂ at 0.33 C between 1.7-3.2 V vs. Li/Li⁺.

FIG. 4. (a) Galvanostatic discharge and (b) charge profiles showing the voltage vs. specific dis/charge capacity for HS—SiO₂ cells at various cycle numbers. All data collected on a cell with electrolyte containing LiTFSI (1 M) in DOL:TEGDME (1:1 v/v) electrolyte with a 60 wt % sulfur cathode containing 5 wt % HS—SiO₂, cycled between 1.7-3.2 V vs. Li/Li⁺ at a rate of 0.33 C. (Cycle numbers selected in accordance with features of interest (FIG. 3), axes scaled to regions of interest).

FIG. 5. Specific discharge capacity over 62 cycles for control cells cointaining LiTFSI (1 M) electrolyte with no additive at 0.33 C between 1.7-3.2 V vs. Li/Li⁺

FIG. 6. (a) Charge profiles showing voltage vs. specific charge capacity for selected cycles (b) P_{C}1 showing voltage vs. specific charge capacity (c) discharge profiles showing specific discharge capacity vs. voltage for selected cycles, and (d) P_{D}1 showing voltage vs. specific discharge capacity. All data collected on a standard electrolyte cell containing LiTFSI (1 M) in DOL:TEGDME (1:1 v/v) with no additive using 60 wt % sulfur cathode, cycled between 1.7-3.2 V vs. Li/Li⁺ at a rate of 0.33 C (axes scaled to regions of interest).

FIG. 7. (a) Raman spectrum (100-3200 cm-1) showing the decreased intensity of S—H stretch in Li₂S, exposed HS—SiO₂ samples and (b) a diagram showing the suggested binding sites of polysulfides, via —SH groups on interior of HS—SiO₂ spheres.

FIG. 8. (a) UV-Vis spectra (250-800 nm) of Li₂Sₓ solutions exposed to x-SiO₂ for 1 h before being spun in a centrifuge and filtered in an Ar-filled glove box and (b) optical photograph of LiSₓ solutions (0.01 M) in DOL/TEGDME (1:1 v/v) used for UV-vis spectra after 1 h of exposure to x-SiO₂ (0.05 g), unfiltered.

FIG. 9. Specific discharge capacity over 180 cycles for standard cells at 0.33 C between 1.7-3.2 V vs. Li/Li⁺

FIG. 10. Absolute capacity retention (% with respect to cycle 5) vs cycle for a range of samples produced in Example 2 showing the superior performance of cathodes containing particles with internal porosity (hollow spheres) and sulfur-group functionalisation.

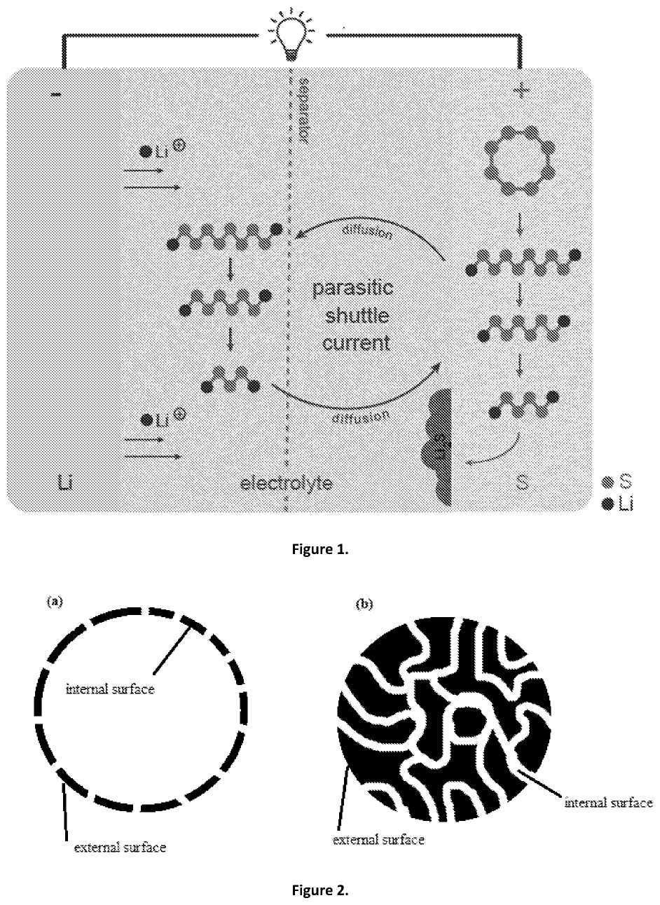

### DEFINITIONS

As used herein, the term “immobilise” is understood to mean the retention, sequestering, concentration, segregation and/or binding of a chemical moiety to another. For example, a “surface adapted to immobilise a polysulfide” is understood that a polysulfide is retained, sequestered, concentrated, segregated on, and/or bound to, the surface adapted for this purpose.

As used herein, the term “adapted” is understood to mean that the adapted thing is designed for a particular purpose, although it may be capable of other uses as well. For example, a “surface adapted to immobilise a polysulfide” refers to a surface that is designed for, or particularly suitable for, immobilising a polysulfide.

As used herein, “particle” or “particles” refers to any material of a particulate nature, that is, less than about 1000 nm in any one, two of three dimensions. The related term “porous particle” refers specifically to particles with at least one pore extending from an external surface into the particle. As the skilled person would appreciate, “particle” without any other qualifying term may refer to a porous or non-porous particle.

As used in this application, the singular form “a”, “an” and “the” include plural references unless the context clearly dictates otherwise.

As used herein, the term “comprising” means “including.” Variations of the word “comprising”, such as “comprise” and “comprises,” have correspondingly varied meanings.

It will be understood that use the term “about” herein in reference to a recited numerical value includes the recited numerical value and numerical values within plus or minus ten percent of the recited value.

It will be understood that use of the term “between” herein when referring to a range of numerical values encompasses the numerical values at each endpoint of the range. For example, a temperature of between 80° C. and 150° ° C. is inclusive of a temperature of 80° C. and a temperature 150° C.

Any description of prior art documents herein, or statements herein derived from or based on those documents, is not an admission that the documents or derived statements are part of the common general knowledge of the relevant art.

For the purposes of description, all documents referred to herein are hereby incorporated by reference in their entirety unless otherwise stated.

### DESCRIPTION OF EMBODIMENTS

The inventors have surprisingly found that including a particle that is adapted to immobilise a polysulfide as an additive in the cathode of a lithium-sulfur battery reduces capacity fading and maintains high Coulombic efficiency even after prolonged cycling. The adaptation includes, for example, functionalisation of a surface with a sulfur-containing functional group. The additive of the invention exhibits strong interactions with polysulfides via covalent chemical bonding to the sulfur-containing functional group. This sulfur functionalisation allows for both uniform sulfur and lithium sulfide deposition within a macromolecular structure that prevents the formation of glassy Li₂S₂ and Li₂S and lowers the overpotentials observed in both charge and discharge, even after extended cycling. A key advantage of the additive of the invention is its ability to promote the uniform deposition of the discharge products (Li₂S₂ and Li₂S) through both chemical and physical mechanisms. Furthermore, the surface of the additive allows for sulfur re-precipitation upon charging in a manner that increases its availability by generating structured high surface area particles.

Without wishing to be bound by theory, the inventors consider that this behavior points to a restructuring of the electrodes that would be consistent with the particle, or particles, providing reactive solid surfaces to reversibly deposit various LiₓS_{y} and polysulfide species.

In one aspect of the invention, there is provided a cathode material for a lithium sulfur battery.

The cathode material may be used to form the active cathode of a lithium sulfur battery, that is, the region of the electrode where reduction takes place. The cathode material may be deposited on a collector to provide an electrical connection with an external circuit. The collector may be, for example, a metal plate or mesh. The metal may be, for example, stainless steel.

The cathode material contains a source of sulfur. This provides the sulfur atoms which are reduced during discharge of the battery (and oxidised during charging). The source of sulfur may be, for example, elemental sulfur, lithium sulfide, or lithium polysulfide.

The cathode material includes a particle having a surface adapted to immobilise a polysulfide. The surface may be adapted in any suitable way to immobilise a polysulfide, for example the surface may be functionalised with a plurality of sulfur-containing functional groups. The particle may be porous, that is, have internal cavities which are accessible via pores from the exterior of the particle. Thus, the porous particle is permeable, e.g. to polysulfides. The porous particle may have various structures. For example, the particle may be in the form of hollow spheres having pores in their spherical external wall (FIG. 2(a)). In another example, the porous particle may be in the form of a solid shape having a plurality of channels (FIG. 2(b)). The porous particle may have an external surface and an internal surface. The external surface is the surface which defines the outside of the particle. The internal surface refers to the surfaces accessed within the particle via the pores (see FIGS. 2(a) and 2(b)).

In one adaptation, the particle is functionalised with a plurality of sulfur-containing functional groups. The functionalisation may be located on the internal surface only, such that the internal surface is functionalised with a plurality of sulfur-containing functional groups and the external surface is substantially free from sulfur-containing functional groups. Alternatively, the functionalisation may be located on the external surface only, such that the external surface is functionalised with a plurality of sulfur-containing functional groups and the internal surface is substantially free from sulfur-containing functional groups. Alternatively, both the internal and the external surface may be functionalized with a plurality of sulfur-containing functional groups.

The sulfur-containing functional group may be any functional group which contains a sulfur atom. Suitable sulfur-containing functional groups include thiol, thioketone, thial, thiocarboxylic acid, dithiocarboxylic acid, sulfonamide, sulfonate, thiosulfonate, sulfone, and xanthate. The particle may be functionalised with one sulfur-containing functional group, or with a combination of two, three, four, five, or more sulfur-containing functional groups. That is, the plurality of sulfur-containing functional groups may comprise a single sulfur-containing functional group, or a combination of two, three, four, five, or more sulfur-containing functional groups.

The sulfur-containing functional groups are joined to the internal or external surface of the particle. The sulfur-containing functional groups may be joined by a covalent bond, an ionic bond, or a bond having a partially covalent and/or partially covalent character. The sulfur-containing functional groups may be joined to the surface of the particle directly. For example, if the functional group is a thioketone, the carbon atom bonded to the sulfur may be joined directly to an atom of the material from which the particle is composed. Alternatively, the sulfur-containing functional groups may be joined to the surface of the particle by a linker molecule. The linker is then joined directly to an atom of the material from which the particle is composed, and the sulfur-containing functional group is joined to the linker. Each linker may carry one sulfur-containing functional group, or each linker may carry multiple sulfur-containing functional groups, for example, two, three, four, five, or more sulfur-containing functional groups.

Suitable linker molecules include linear or branched C₁ to C₃₂ alkyl chains, C₁ to C₃₂ alkenyl chains, or C₁ to C₃₂ alkaryl chains. In one embodiment, the linker molecule is a C₁ to C₁₈ alkyl chain, C₁ to C₁₈ alkenyl chain, or C₁ to C₁₈ alkaryl chain. In one embodiment, the linker molecule is a C₁ to C₁₂ alkyl chain, C₁ to C₁₂ alkenyl chain, or C₁ to C₁₂ alkaryl chain. An alkyl chain is understood to be comprised of fully saturated carbon atoms. An alkenyl chain is understood to be an alkyl chain which includes one or more double bonds within the chain, e.g. a C₆ alkyl chain may be —CH₂CH═CHCH₂CH₂CH₃. An alkaryl chain is understood to be an alkyl chain which includes one or more aryl groups, e.g. a C₆ alkaryl chain may be —CH₂—(C₆H₄)—CH₂CH₂CH₃ (note only the carbon atoms by which the aryl group is joined to the chain are counted towards the length of the chain).

The linker may be optionally substituted with other functional groups in order to tune the steric or electronic properties of the sulfur-containing functional group. “Substituted” means that in a linker molecule one or more bonds to a hydrogen atom are replaced by a bond to a non-hydrogen atom. “Optionally substituted” as used herein means that any atom of the linker may be unsubstituted (i.e. only substituted by hydrogens), or may be substituted with one or more groups independently selected from alkyl, alkenyl, alkynyl, cycloalkyl, cycloalkenyl, heterocycloalkyl, halogen, haloalkyl, hydroxyl, hydroxyalkyl, alkoxy, thioalkoxy, alkenyloxy, haloalkoxy, —NO₂, —NH(alkyl), —N(alkyl)₂, —N+(alkyl)₃, alkylamino, dialkylamino, acyl, alkenoyl, alkynoyl, acylamino, diacylamino, acyloxy, heterocycloxy, heterocycloamino, optionally alkyl and/or aryl substituted C₅-C₇ N- and/or O-containing heterocyclic, haloheterocycloalkyl, alkylcarbonyloxy, phosphorus-containing groups such as phosphono and phosphinyl, aryl, heteroaryl, alkylaryl, aralkyl, alkylheteroaryl, cyano, aldehyde, —CO₂H, —CO₂alkyl, —C(O)NH₂, —C(O)NH(alkyl), and —C(O)N(alkyl)₂. Preferred substituents include halogen, —NO₂, C₁-C₆alkyl, C₁-C₆haloalkyl, C₁-C₆alkoxy, hydroxy(C₁₋₆)alkyl, C₃-C₆cycloalkyl, —C(O)OH, —C(O)OC₁-C₄alkyl, —NHC(O)C₁-C₄alkyl, —C(O)C₁-C₄alkyl, —NH₂, —NHC₁-C₄alkyl, —N(C₁-C₄alkyl)₂, —N⁺(C₁-C₄alkyl)₃, alkyl and/or aryl-imidazolium, —SO₂(C₁-C₄alkyl), —OH and —CN.

In some embodiments, the source of sulfur is encapsulated within the particle. That is, for example, the source of sulfur is located within the internal cavities of a particle, such as a porous particle or a hollow particle. All or substantially all of the source of sulfur may be encapsulated within the particle. At least 80, 85, 90, 95, or 100% of the source of sulfur may be encapsulated within the particles. In one embodiment, the cathode material is prepared with the source of sulfur encapsulated within the particle prior to use (charging and/or discharging) in a lithium sulfur battery. In another embodiment, when the cathode is used in a lithium sulfur battery (i.e. the battery is charged and discharged), the at least a portion of the source of sulfur becomes encapsulated within the particle.

The pore volume of the porous particle may be at least about 0.1 cm³/g. The pore volume of the porous particles may between about 0.1-10 cm³/g, or 0.1-0.25, 0.1-0.5, 0.1-1, 0.1-2, 0.1-3, 0.1-4.0.1-5, 0.1-6, 0.1-7, 0.1-8, 0.1-9, 0.25-0.5, 0.25-1, 0.25-2, 0.25-3, 0.25-4, 0.25-5, 0.25-6, 0.25-7, 0.25-8, 0.25-9, 0.25-10, 0.5-1, 0.5-2, 0.5-3, 0.5-4, 0.5-5, 0.5-6, 0.5-7, 0.5-8, 0.5-9, 0.5-10, 1-2, 1-3,1-4, 1-5, 1-6, 1-7, 1-8, 1-9, 1-10, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, or 9-10 cm³/g. The pore volume of the porous particle may about 0.1 cm³/g, or about 0.25, 0.5, 1, 2, 3, 4, 5, 6, 7, 8, 9, or 10 cm³/g. Pore volume may be calculated from nitrogen adsorption measurements, based on the amount adsorbed at P/P₀ of 0.99.

The Brunauer-Emmett-Teller surface area of the porous particle may be at least 70 m²/g. The Brunauer-Emmett-Teller surface area of the porous particles may be between about 70-1000 m²/g, or 70-100, 70-200, 70-300, 70-400, 70-500, 70-600, 70-700, 70-800, 70-900, 100-200, 100-300, 100-400, 100-500, 100-600, 100-700, 100-800, 100-900, 100-1000, 200-300, 200-400, 200-500, 200-600, 200-700, 200-800, 200-900, 200-1000, 300-400, 300-500, 300-600, 300-700, 300-800, 300-900, 300-1000, 400-500, 400-600, 400-700, 400-800, 400-900, 400-1000, 500-600, 500-700, 500-800, 500-900, 500-1000, 600-700, 600-800, 600-900, 600-1000, 700-800, 700-900, 700-1000, 800-900, 800-1000, or 900-1000 m²/g. The Brunauer-Emmett-Teller surface area of the porous particle may be about 70 m²/g, or about 100, 200, 300, 400, 500, 600,700, 800, 900, or about 1000 m²/g.

The average pore diameter of the porous particle may be between about 0.1 nm-5 μm. The average pore diameter of the porous particle may be between about 0.1-1000 nm, or 0.1-1, 0.1-2.5, 0.1-5, 0.1-10, 0.1-20, 1-2.5, 1-5, 1-10, 1-20, 2.5-5, 5-10, 5-20, 5-30, 10-20, 10-30, 10-40, 10-50, 10-100, 25-50, 25-100, 25-250, 25-500, 50-100, 50-250, 50-500, 100-250, 100-00, 100-400, 100-500, 100-600, 100-700, 100-800, 100-900, 100-1000, 200-300, 200-400, 200-500, 200-600, 200-700, 200-800, 200-900, 200-1000, 300-400, 300-500, 300-600, 300-700, 300-800, 300-900, 300-1000, 400-500, 400-600, 400-700, 400-800, 400-900, 400-1000, 500-600, 500-700, 500-800, 500-900, 500-1000, 600-700, 600-800, 600-900, 600-1000, 700-800, 700-900, 700-1000, 800-900, 800-1000, or 900-1000 nm. The average pore diameter of the porous particle may be between about 0.5-5 μm, or between about 0.5-1, 0.5-1.5, 0.5-2.5, 1-2, 1-3, 1-4, 2-3, 2-4, 2-5, 2-4, 3-5, or 4-5 μm. The average pore diameter of the porous particle may be about 0.1 nm, or about 1, 2.5, 5, 10, 20, 30, 40, 50, 60, 70, 80, 90, 100, 200, 250, 300, 400, 500, 600, 700, 800, or 900 nm, or about 1 μm, or about 1.5, 2, 2.5, 3, 3.5, 4, 4.5, or 5 μm. The pore diameter may be determined from nitrogen adsorption measurements, specifically from the adsorption branch by the Barrett-Joyner-Halenda method.

The degree of functionalisation of the particle with the sulfur-containing functional groups may be between about 0.1 to 3 mmol/g. The degree of functionalisation of the porous particles with the sulfur-containing functional groups may be between about 0.1 to 0.5, 0.1-1, 0.1-1.5, 0.1-2, 0.1-2.5, 0.5-1, 0.5-1.5, 0.5-2, 0.5-2.5, 0.5-3, 1-1.5, 1-2, 1-2.5, 1-3, 1.5-2, 1.5-2.5, 1.5-3, 2-2.5, 2-3, or 2.5-3 mmol/g. The degree of functionalisation with sulfur-containing groups may be determined, for example, by elemental analysis (ICP-MS) or thermogravimetric analysis (TGA).

The diameter of the particle may be between about 5 nm-500 μm. The diameter of the porous particle may be between about 5-1000 nm, or 5-10, 5-20, 5-30, 10-20, 10-30, 10-40, 10-50, 10-100, 25-50, 25-100, 25-250, 25-500, 50-100, 50-250, 50-500, 100-250, 100-00, 100-400, 100-500, 100-600, 100-700, 100-800, 100-900, 100-1000, 200-300, 200-400, 200-500, 200-600, 200-700, 200-800, 200-900, 200-1000, 300-400, 300-500, 300-600, 300-700, 300-800, 300-900, 300-1000, 400-500, 400-600, 400-700, 400-800, 400-900, 400-1000, 500-600, 500-700, 500-800, 500-900, 500-1000, 600-700, 600-800, 600-900, 600-1000, 700-800, 700-900, 700-1000, 800-900, 800-1000, or 900-1000 nm. The diameter of the porous particle may be between about 1-500 μm, or between about 1-10, 1-20, 1-50, 1-100, 1-250, 10-20, 10-50, 10-100, 10-250, 10-500, 20-50, 20-100, 20-250, 20-500, 50-100, 50-150, 50-500, 100-250, 100-200, 100-300, 100-400, 100-500, 200-300, 200-400, 200-500, 300-400, 300-500, or 400-500 μm. The diameter of the porous particle may be about 5 nm, or about 10, 20, 30, 40, 50, 100, 200, 300, 400, 500, 600, 700, 800, or 900 nm. The diameter of the particle may be about 1 μm, or about 10, 20, 50, 100, 200, 300, 400, or about 500 μm.

As discussed above, the particle may have various structures. When the particle is in the form of hollow spheres having pores in their spherical external wall, the wall thickness may be between about 1-500 nm and the diameter of the internal cavity may be between about 1 nm-100 μm. The wall thickness may be between about 1-500 nm, or between about 1-5, 1-10, 1-20, 1-50, 1-100, 1-200, 5-10, 5-20, 5-50, 5-100, 5-200, 5-500, 10-20, 10-50, 10-100, 10-200, 10-500, 20-50, 20-100, 20-200, 20-300, 20-400, 20-500, 50-100, 50-200, 50-300, 50-400, 50-500, 100-200, 100-300, 100-400, 100-500, 200-300, 200-400, 200-500, 300-400, 300-500, or 400-500 nm. The wall thickness may be about 1 nm, or about 5, 10, 20, 50, 100, 200, 300, 400, or 500 nm. The diameter of the internal cavity may be between about 1 to 1000 nm, or about 1-2.5, 1-5, 1-10, 1-20, 2.5-5, 5-10, 5-20, 5-30, 10-20, 10-30, 10-40, 10-50, 10-100, 25-50, 25-100, 25-250, 25-500, 50-100, 50-250, 50-500, 100-250, 100-00, 100-400, 100-500, 100-600, 100-700, 100-800, 100-900, 100-1000, 200-300, 200-400, 200-500, 200-600, 200-700, 200-800, 200-900, 200-1000, 300-400, 300-500, 300-600, 300-700, 300-800, 300-900, 300-1000, 400-500, 400-600, 400-700, 400-800, 400-900, 400-1000, 500-600, 500-700, 500-800, 500-900, 500-1000, 600-700, 600-800, 600-900, 600-1000, 700-800, 700-900, 700-1000, 800-900, 800-1000, or 900-1000 nm. The diameter of the internal cavity may be between about 1-100 μm, or between about 1-5, 1-10, 1-20, 1-50, 5-10, 5-20, 5-50, 5-100, 10-20, 10-50, 10-100, 25-50, 25-75, 25-100, 50-75, 50-100, or 75-100 μm. The diameter of the internal cavity may be about 1 nm, or about 2.5, 5, 10, 20, 30, 40, 50, 60, 70, 80, 90, 100, 200, 300, 400, 500, 600, 700, 800, or 900 nm. The diameter of the internal cavity may about 1 μm, or about 5, 10, 20, 30, 40, 50, 60, 70, 80, 90, or 100 μm.

The cathode material of the invention may also further comprise a binder. The binder is a polymer which causes the components of the cathode material to adhere together. Suitable binders include fluorinated polymers (such as poly(vinylidene fluoride) (PVDF), poly(vinylidene fluoride)-co-hexafluoropropylene (PVDF-HFP) and polytetrafluoroethylene (PTFE)), cellulose derivatives (such as CMC), polyacrylic nitrides, polyacrylic acids, co-acrylic acids, styrene butadiene, and ionic polymers.

### Non-Conductive Particle

The particle of the invention may be composed of a non-conductive material. By a non-conductive material it is meant a material which has a conductivity of less than 100 S/m. Suitable non-conductive materials include silica, titania, zeolite, aluminosilicate, and aluminosilica. In this embodiment, the cathode material of the invention comprises a source of sulfur, a conductive material, and the particle.

If the particle of the invention is composed of a non-conductive material, a conductive material should be included in the cathode material. As the source of sulfur is an insulator it must be supported by a conductive framework to facilitate conduction to the external circuit. By a conductive material it is meant a material which has a conductivity of more than or equal to 100 S/m. The conductive material is typically a carbon material. Suitable carbon-based conductive materials include carbon black, carbon nanotubes, mesoporous carbon, graphene, graphite, expanded graphite, graphene oxides, activated carbons, glassy carbons, and diamond-like carbons. The conductive material may alternatively be a transition metal oxide or nitride, for example vanadium, zirconium or titanium nitride.

In the cathode material having a non-conductive particle, the source of sulfur, conductive material, a plurality of particles, and binder (if present) are combined in suitable ratios. Where the conductive material=x, source of sulfur=y, porous particles=z, the binder=q, and x+y+z+q (if present)=100 wt. %, the amounts of the components of the cathode material may be as follows: 3 wt. %≤x≤70 wt. %, 20 wt. %≤y≤90 wt. %; 1 wt. %≤z≤70 wt. %, and, if present, 0.1 wt. %≤q≤20 wt. %.

Thus, the cathode material may contain between about 3 to about 70 wt. % of the conductive material (x), or between about 3 to 10, 3 to 20, 3 to 30, 3 to 40, 3 to 50, 3 to 60, 10 to 20, 10 to 30, 10 to 40, 10 to 50, 10 to 60, 10 to 70, 20 to 30, 20 to 40, 20 to 50, 20 to 60, 20 to 70, 30 to 40, 30 to 50, 30 to 60, 30 to 70, 40 to 50, 40 to 60, 40 to 70, 50 to 60, 50 to 70, or between about 60 to 70 wt. % of the conductive material. The cathode may contain the conductive material in an amount of about 3, 10, 20, 30, 40, 50, 60, or about 70 wt. %.

The cathode material may contain between about 20 to about 90 wt. % of the source of sulfur (y), or between about 20 to 30, 20 to 40, 20 to 50, 20 to 60, 20 to 70, 20 to 80, 30 to 40, 30 to 50, 30 to 60, 30 to 70, 30 to 80, 30 to 90, 40 to 50, 40 to 60, 40 to 70, 40 to 80, 40 to 90, 50 to 60, 50 to 70, 50 to 80, 50 to 90, 60 to 70, 60 to 80, 60 to 90, 70 to 80, 70 to 90, or between about 80 to 90 wt. % of the source of sulfur.

The cathode material may contain between about 1 to about 70 wt. % of the particles (z), or between about 1 to 2.5, 1 to 5, 1 to 10, 1 to 20, 2.5 to 5, 2.5 to 10, 5 to 10, 5 to 20, 10 to 20, 10 to 30, 10 to 40, 10 to 50, 10 to 60, 10 to 70, 20 to 30, 20 to 40, 20 to 50, 20 to 60, 20 to 70, 30 to 40, 30 to 50, 30 to 60, 30 to 70, 40 to 50, 40 to 60, 40 to 70, 50 to 60, 50 to 70, or between about 60 to 70 wt. % of the particles.

If present, the cathode material may contain between about 0.1 to about 20 wt. % of the binder (q), or between about 0.1 to 0.5, 0.1 to 1, 0.1 to 2.5, 0.1 to 5, 0.5 to 1, 0.5 to 2.5, 0.5 to 5, 1 to 2.5, 1 to 5, 1 to 10, 1 to 15, 1 to 20, 5 to 10, 5 to 15, 5 to 20, 10 to 15, 10 to 20, or between about 15 to 20 wt. % of the binder.

Thus, in one embodiment of the invention, the cathode material of the invention may be a mixture of the source of sulfur, non-conductive porous particles, a conductive material, and optionally a binder. The mixture may be a homogenous, or substantially homogeneous mixture. Alternatively, the components of the cathode material may be arranged to form layers.

### Conductive Particles

The particle of the invention may alternatively be composed of a conductive material. That is, the particle provide the conductive framework to facilitate conduction to the external circuit. By a conductive material it is meant a material which has a conductivity of more than or equal to 100 S/m. Suitable conductive materials of which the particle may be composed include carbon, and transition metal oxides or nitrides, for example vanadium, zirconium or titanium nitride.

In this embodiment, the cathode material of the invention may comprise solely a source of sulfur, the particle, and optionally a binder.

Where the particle of the invention is composed of the conductive material, in some cases the cathode material may benefit from a further increase in conductivity. This may be achieved by including a further conductive material in the cathode material. The further conductive material may be a material which has a conductivity of more than or equal to 100 S/m. The further conductive material is typically a carbon material. Suitable carbon-based further conductive materials include carbon black, carbon nanotubes, mesoporous carbon, graphene, graphite, expanded graphite, graphene oxides, activated carbons, glassy carbons, and diamond-like carbons. The further conductive material may alternatively be a transition metal oxide or nitride, for example vanadium, zirconium or titanium nitride.

In the cathode material having a conductive particle of the invention, the source of sulfur, further conductive material (if present), a plurality of the porous particles, and binder (if present) are combined in suitable ratios. Where the further conductive material=x, source of sulfur=y, porous particles=z, the binder=q, and x (if present)+y+z+q (if present)=100 wt. %, the amounts of the components of the cathode material may be as follows: if present, 1 wt. %≤ x≤30 wt. %, 20 wt. %≤ y≤90 wt. %; 1 wt. %≤ z≤70 wt. %, and, if present. 0.1 wt. %≤ q≤20 wt. %.

Thus, if present, the cathode material may contain between about 1 to about 30 wt. % of the further conductive material (x), or between about 1 to 5, 1 to 10, 1 to 15, 1 to 20, 1 to 25, 5 to 10, 5 to 15, 5 to 20, 5 to 25, 5 to 30, 10 to 15, 10 to 20, 10 to 25, 10 to 30, 15 to 20, 15 to 25, 15 to 30, 20 to 25, 20 to 30, or between about 25 to 30 wt. % of the further conductive material. The cathode may contain the further conductive material in an amount of about 1, 5, 10, 15, 20, 25, or about 30 wt. %.

The cathode material may contain between about 20 to about 90 wt. % of the source of sulfur (y), or between about 20 to 30, 20 to 40, 20 to 50, 20 to 60, 20 to 70, 20 to 80, 30 to 40, 30 to 50, 30 to 60, 30 to 70, 30 to 80, 30 to 90, 40 to 50, 40 to 60, 40 to 70, 40 to 80, 40 to 90, 50 to 60, 50 to 70, 50 to 80, 50 to 90, 60 to 70, 60 to 80, 60 to 90, 70 to 80, 70 to 90, or between about 80 to 90 wt. % of the source of sulfur.

The cathode material may contain between about 1 to about 70 wt. % of the porous particles (z), or between about 1 to 2.5, 1 to 5, 1 to 10, 1 to 20, 2.5 to 5, 2.5 to 10, 5 to 10, 5 to 20, 10 to 20, 10 to 30, 10 to 40, 10 to 50, 10 to 60, 10 to 70, 20 to 30, 20 to 40, 20 to 50, 20 to 60, 20 to 70, 30 to 40, 30 to 50, 30 to 60, 30 to 70, 40 to 50, 40 to 60, 40 to 70, 50 to 60, 50 to 70, or between about 60 to 70 wt. % of the porous particles.

If present, the cathode material may contain between about 0.1 to about 20 wt. % of the binder (q), or between about 0.1 to 0.5, 0.1 to 1, 0.1 to 2.5, 0.1 to 5, 0.5 to 1, 0.5 to 2.5, 0.5 to 5, 1 to 2.5, 1 to 5, 1 to 10, 1 to 15, 1 to 20, 5 to 10, 5 to 15, 5 to 20, 10 to 15, 10 to 20, or between about 15 to 20 wt. % of the binder.

Thus, in one embodiment of the invention, the cathode material of the invention may be a mixture of the source of sulfur, conductive porous particles, optionally a further conductive material, and optionally a binder. The mixture may be a homogenous, or substantially homogeneous mixture. Alternatively, the components of the cathode material may be arranged to form layers.

### Lithium Sulfur Battery

In another aspect of the invention, there is provided a lithium sulfur battery comprising the cathode material of the invention. The lithium sulfur battery of the invention contains the cathode material of the invention as described above, an anode comprising a lithium source, and an electrolyte disposed between the cathode and the anode. The battery may also comprise current collectors in contact with the anode and the cathode, and a membrane and/or separator disposed between the anode and the cathode. The arrangement of anode, membrane and/or separator, and cathode may singular, as in the case of a coin cell architecture. In the case of other cell architectures, such as a pouch cell, this arrangement of anode, membrane and/or separator, and cathode may be repeated. In the case of a repeated architecture the current collectors of the anodes and the current collectors of the cathodes may be welded.

The lithium source of the anode of the battery of the invention provides lithium atoms which are oxidised during discharge of the battery. Suitable lithium sources include lithium metal, lithiated silicon (an alloy of lithium and silicon) and lithiated carbon. Lithiated carbon may refer to lithium ions intercalated within a graphite framework, or lithium metal plated on carbon.

The electrolyte of the battery of the invention may be any suitable electrolyte, such as a liquid electrolyte comprising a lithium salt dissolved in one or more solvents. The electrolyte may also be a gel or a polymer electrolyte comprising a lithium salt. Suitable lithium salts include LiTFSI, LIFSI, LITFSM, LiPF₆, LiClO₄, LiBF₄, LIBETI, LiFAP, LiFAB, LiBOB, LiODFB, LiFAP, LiFBMSI, salts with the formulas Li(CₙF2ₙ₊₁SO₃) (n=1, 4 and 8), Li[N(ROSO₂)₂] (R—CF₃CH₂, HCF₂CF₂CH₂, CF₃CF₂CH₂ or (CF₃):CHOSO₂), Li[BF₄₋ₙ(CF₃)ₙ] (n=1, 2, 3 and 4), Li[PF₆₋ₙ(CF₃)ₙ] (n=1,2 and 3), Li[N(RSO₂)(R′SO₂)] (R=C₆F₅, C₄F₉ or C₈F₁₇; R′=CF₃). Li[N(FSO₂)(n-C₄F₉SO₂)] (LIFNFSI), and Li[BF₃Cl]. Each of these salts may be present at a concentration between 0.1 M and 5 M in the electrolyte. Suitable solvents include ethers, optionally alkyl ethers, alkyl glymes, or fluorinated ethers, monomeric, oligomeric or polymeric alkenyl carbonates, fluorinated carbonates, and ionic liquids, optionally combinations of nitrogen based cations such as imidazolium, quaternary ammonium, pyrazolium, pyrrolidinium and piperidinium cations, more specifically 1-butylpyridinium, 1-octylpyridinium, 1-(2-hydroxyethyl)pyridinium, 1-ethyl-3-methylimidazolium, 1-butyl-3-methylimidazolium, 1-pentyl-3-methylimidazolium, 1-hexyl-3-methylimidazolium, 1-(2-methoxyethyl)-3-methylimidazolium, 1-(1-methoxymethyl)-3-methylimidazolium, 1-methyl-3-octylimidazolium, 1-methyl-1-ethylpyrolidinium, 1-methyl-1-butylpyrrolidinium, 1-methyl-1-hexylpyrolidinium, 1-(2-methoxyethyl)-1-methylpyrrolidinium, 1-(1-methoxymethyl)-1-methylpyrrolidinium, tetraethylammonium, tetrabutylammonium, tributyloctylammonium, tributyl(2-methoxyethyl)ammonium, tributyl(1-methoxymethyl)ammonium, and tributyl-tert-butylammonium, phosphonium cations such as tetrabutylphosphonium, tributyloctylphosphonium, trihexyltetradecylphosphonium, tributyl(2-methoxyethyl)phosphonium, tributyl-tert-butylphosphonium, tributyl(1- and methoxymethyl)phosphonium, and anions selected from PF₆⁻, BF4-, bis(fluorosulfonyl)imide (FSI), and bis(trifluoromethanesulfonyl)imide (TFSI⁻), hexafluoro-phosphate, tris(pentafluoro)trifluorophosphate, acetate, propionate, pentanoate and hexanoate. Particularly suitable ethers are glycol ethers (glymes). For example, a suitable electrolyte solution is LiTFSI (1 M) in 1:1 (v/v) dioxolane:tetraethylene glycol dimethyl ether. The electrolyte may also contain an additive, such as lithium nitrate. The electrolyte may contain lithium nitrate at a concentration between about 0.01 and 1 M. Alternatively, the electrolyte may contain no additives.

A lithium sulfur battery of the invention may exhibit a Coulombic efficiency of at least about 70% after 100 cycles, or of at least about 75, 80, 85, 90, 95, or 100% after 100 cycles. The lithium sulfur battery of the invention may exhibit a Coulombic efficiency of at least about 70% after 250 cycles, or of at least about 75, 80, 85, 90, 95, or 100% after 250 cycles. The lithium sulfur battery of the invention may exhibit a Coulombic efficiency of at least about 70% after 500 cycles, or of at least about 75, 80, 85, 90, 95, or 100% after 500 cycles. Coulombic efficiency refers to the ratio of charge transferred to the external circuit during discharge versus the charge transferred back to the cell to fully charge it.

In a lithium sulfur battery of the invention, the specific discharge capacity of the battery may not decrease by more than about 30% of its initial value after 100 cycles. The specific discharge capacity of the battery may not decrease by more than about 30% of its initial value after 100 cycles, or by more than about 25, 20, 15, 10, 5, 2.5 or 1% of its initial value after 100 cycles. The specific discharge capacity of the battery may not decrease by more than about 30% of its initial value after 250 cycles, or by more than about 25, 20, 15, 10, 5, 2.5 or 1% of its initial value after 250 cycles. The specific discharge capacity of the battery may not decrease by more than about 30% of its initial value after 500 cycles, or by more than about 25, 20, 15, 10, 5, 2.5 or 1% of its initial value after 500 cycles. Specific discharge capacity is defined as the charge capacity (mAh) divided by the mass of active material (that is, the cathode material of the invention).

In another aspect of the invention there is provided a use of a particle of the invention in the cathode of a lithium sulfur battery. The particle has a surface adapted to immobilize a polysulfide.

In the use of the invention, the surface adapted to immobilise a polysulfide may comprise an internal surface and an external surface, wherein the internal surface and/or the external surface is functionalised with a plurality of sulfur-containing functional groups, and wherein the particle is present in the cathode in an amount of less than 70 wt. %. The particle may be porous. The particle and the lithium sulfur battery are as described above in relation to the cathode material of the invention.

In the use of the invention, the particle is added to the cathode of a lithium sulfur battery. The cathode material may contain other components, such as a source of sulfur and a conductive material or a further conductive material, as described above. The components of the lithium sulfur battery, source of sulfur, conductive material, further conductive material, anode, lithium source, electrolyte, cathode, particle, and sulfur-containing functional groups are as described above in relation to the cathode material of the invention.

In another aspect of the invention, there is provided a method of reducing capacity fading of a lithium sulfur battery, the battery comprising a cathode comprising a source of sulfur, an anode comprising a lithium source, and an electrolyte, the method comprising adding a particle to the cathode, wherein the particle has an internal surface and an external surface, wherein the internal surface and/or external surface is functionalised with a plurality of sulfur-containing functional groups. The components of the lithium sulfur battery, source of sulfur, conductive material, further conductive material, anode, lithium source, electrolyte, cathode, particle, and sulfur-containing functional groups are as described above in relation to the cathode material of the invention.

### EXAMPLES

### General

CR2032 coin cell stainless steel casings, spacers and wave springs (all TOB New Energy), and glass fibre separators were cut from 0.7 μm pore size filter paper (Millipore) were used as received. Lithium foil discs (16 mm) (TOB Machine) were used as received.

### Galvanostatic Battery Cycling

Galvanostatic battery cycling data was collected using a BTS4000 battery testing system. Charging and discharging currents were determined relative to the mass of active material present in the cathode. This was estimated by recording the mass of the electrode before cell assembly and subtracting the mean mass of ten blank Al foil current collectors. Using the theoretical capacity of sulfur (1672 mAh/g) a discharge rate was selected such that the cells be cycled at a rate of 0.3 C unless otherwise stated. Cells were cycled between 1.8-3.2 V.

### Electrode Coating

All electrode coating was done using an Erichsen Coatmaster 510 at a temperature of 70° C. using Erichsen Model 358 spiral applicators.

### High Shear Mixing (Homogeniser)

An AN AD200L-P High Shear Mixer was used for all homogenisation procedures.

### Ultraviolet-Visible Spectroscopy (UV-Vis)

An Agilent Technologies Cary 60 UV-Vis spectrometer was used to collect all UV-Vis data. Polysulfide studies were conducted by making a solution Li₂Sₓ (x=1-6) (0.01 M) in 1,3-dioxolane:tetra ethylene glycol dimethyl ether (1:1 v/v) and exposing it to x-SiO₂ samples for 60 min in an Ar-filled glove box before spinning samples in a centrifuge (8000 rpm) for 30 min and decanting the solution into a sealed quartz cuvette under an inert atmosphere. UV-Vis spectra were then collected for the x-SiO₂ exposed Li₂Sₓ solutions a control sample of Li₂Sₓ (0.01 M).

### Infrared Spectroscopy (IR)

IR spectra were collected using a PerkinElmer Spectrum Two FT-IR Spectrometer equipped with a LiTaO₃ detector and an ATR accessory from 400-4000 cm-1. All samples were crushed into a power and data was collected in the solid state. Data is reported using the following notation: wavenumber (cm⁻¹), relative strength and shape (s, strong; m, medium; w, weak; b, broad), peak assignment.

### Raman Spectroscopy

Raman spectroscopy was performed using a Renishaw in Via Qontor confocal Raman microscope.

### Standard Electrode Preparation

Dry materials were combined in a specified mass ratio and ground using a mortar and pestle. Poly(vinylidene fluoride) (PVDF) (0.10 g) was dissolved in 1-methyl-2-pyrrolidinone (NMP) (1.25 mL) and stirred at 70° C. for 2 h until transparent and free from air bubbles. The PVDF solution was then added with additional NMP (1 mL) added to ensure complete transfer. The slurry was then homogenised for 0-30 min before being stirred at 1400 rpm for at least 6 h, heating at 70° C. The slurry was then coated onto aluminium (Al) foil (25 μm) at 70° C. using a spiral coating bar to give a thickness of 100 μm. The speed of coating was 50 mm/s. Initial evaporation of NMP occurred after heating at 70° C. for 45 min. The coated Al foil was then dried for 24 h at 50° ° C. at reduced pressure. The coated Al foil was cut into 12 mm discs using a marking laser. All components were dried at reduced pressure at room temperature unless already stored in an Ar-filled glovebox.

### Example 1—Porous Particles

Preparation of Porous Particles (x-SiO₂)

Silica porous particles were synthesised according to the method of RSC Adv., 2015, 5, 105747-105752, which is summarised as follows for propylthiol functionalised silica. It is understood that (3-mercaptopropyl)trimethoxysilane (MPTMS) and tetramethoxysilane (TMOS) may be replaced with a different sulfur-containing silane to provide porous particles having different functionalistion.

0.40 g Pluronic F127 (M_{w}=12600, EO₁₀₆PO₇₀EO₁₀₆) and 1.40 g K₂SO₄ were dissolved in 24 mL of deionised water at 13.5° C. under vigorous stirring. Then, a mixture of 0.40 g trimethylbenzene (TMB) and 0.20 g (3-mercaptopropyl)trimethoxysilane (MPTMS) was added quickly. After pre-hydrolysis for 3 h, 1.20 g of tetramethoxysilane (TMOS) was added. The molar composition of the mixture was TMOS/F127/MPTMS/TMB/K₂SO₄/H2O=1:0.0040:0.13:0.42:1.02:169. The resultant mixture was stirred at 13.5° C. for 24 h and aged at 100° ° C. under static conditions for an additional 24 h. The solid product was recovered by filtration and air-dried at room temperature overnight. The surfactant was extracted by refluxing 1.0 g of as synthesised material in 200 mL of ethanol containing 1.5 g of HCl (36.5 wt. %) for 24 h. After filtration the material was washed thoroughly with water and ethanol, and the sample was dried.

Porous particles, in the form of hollow nanospheres, of propylthiol functionalised silica (HS—SiO₂) and phenyl functionalised silica (Ph-SiO₂) were prepared according to the above method (trimethoxphenylysilane replacing (3-mercaptopropyl)trimethoxysilane to form Ph-SiO₂). HS—SiO₂ hollow nanospheres have a Brunauer-Emmett-Teller surface area of 492 m²·g⁻¹ with an average pore size of 10.8 nm. Ph-SiO₂ have Brunauer-Emmett-Teller surface area of 564 m²·g⁻¹ with a pore size of 10.1 nm.

Porous Particle (x-SiO₂) Equipped Coin Cells with Standard Electrolyte

Slurries for x-SiO₂ equipped cells were prepared as described above with the following ratio of dry materials.

Functionalised silica containing electrode slurries had a dry mass composition ratio of 60:25:10:5 (elemental sulfur/Super P carbon black/PVDF/x-SiO₂). Typically, dry components elemental sulfur (0.60 g), Super P carbon black (0.25 g), and x-SiO2 (0.05 g) were weighed and ground in a mortar and pestle until homogenous.

x-SiO₂ equipped CR2032 coin cells were assembled in an Ar-filled glovebox. Cells were assembled bottom to top: stainless-steel (SS) anode casing, wave spring, SS spacer, Li foil anode, glass fibre separator (25 μm), ˜50 μL of electrolyte, x-SiO₂ electrode, SS cathode casing. The electrolyte composition was a LiTFSI solution in a 1:1 (v/v) mixture of DOL and TEGDME or DME with 1 wt % LiNO₃.

Coin Cells with 4,4′-Dimercaptoazobenzene (DMAB) Electrolyte (Comparative Example with Molecular Additive)

Poly(vinylidene fluoride) (PVDF) (0.10 g) was dissolved in 1-methyl-2-pyrrolidinone (NMP) (1.25 mL) and stirred at 70° C. for 2 h until transparent and free from air bubbles. The ground powders were placed in a glass vial and NMP (4.00 mL) was added. The PVDF solution was then added with additional NMP (0.75 mL) added to ensure complete transfer. The slurry was then homogenised for 30 min before being stirred at 1400 rpm for at least 6 h, heating at 70° C. The slurry was then coated onto aluminium (Al) foil (25 μm) at 70° ° C. using a spiral coating bar to give a thickness of 100 μm. The speed of coating was 50 mm/s. Initial evaporation of NMP occurred after heating at 70° C. for 45 min. The coated Al foil was then dried for 24 h at 70° C. The coated Al foil was cut into 12 mm discs using a marking laser. All components were dried in vacuo at room temperature unless already stored in an Ar-filled glovebox.

DMAB was dissolved in a LiTFSI (1 M) TEGDME:DOL (1:1 v/v) solution to make a 25 mM solution of DMAB electrolyte.

### Functionalised Silica Adsorption of Polysulfides

In an Ar-filled glovebox, x-SiO2 (˜0.1 g) was exposed to a DOL:TEGDME solution of Li2Sx (x=1-6) (0.1 M) for 60 min before being filtered and dried in vacuo for 2 h.

Electrochemical and Spectroscopic Testing of Cells with HS—SiO₂ Porous Particle Additive

HS—SiO₂ was incorporated in electrodes at 5 wt % and used in cells containing a standard LiTFSI (1 M) DOL:TEGDME (1:1 v/v) electrolyte with a lithium metal anode. The interactions of the additive with polysulfides are investigated using a variety of spectroscopic and electrochemical techniques.

All cells equipped with HS—SiO₂ showed a significant increase in capacity retention over the first 120 cycles when compared with control cells containing no functionalised silica additive. Capacity retention for HS—SiO₂ at cycle 120 is 98.8% of the 885 mAh·g⁻¹ initial specific discharge capacity, while being 87.7% of the 996 mAh·g-1 maximum specific discharge capacity recorded in cycle 49 (FIG. 3). This is a result of an increase from initial discharge capacity upon cycling, a phenomenon uncharacteristic of most Li—S research cells. Improved capacity retention over extended cycling compared to control cells is largely attributed to the ability of HS—SiO₂ to localise polysulfide anions to the cathodic region, limiting their diffusion, as well as the uniform deposition of both sulfur and lithium sulfide on the sulfur cathode promoted by the presence of thiol functionalised silica.

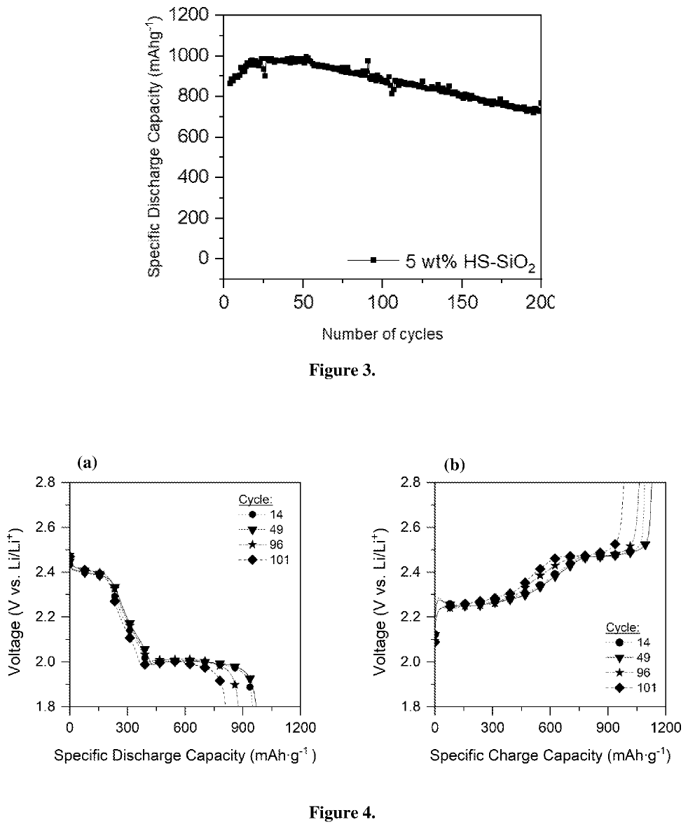

The charge-discharge profiles of HS—SiO₂ equipped cells (FIG. 4) maintained a consistent P_{D}1 capacity contribution even after 101 cycles, the result of elemental S₈ reduction to S₈²⁻ anions. Compared with standard cells the quantity of available S₈ did not decrease after extended cycling, indicating more uniform sulfur deposition and superior control of polysulfides. Despite an outlying decrease in the size of P_{D}2 during cycle 21, the capacity contribution decreased at a slower rate than for control cells.

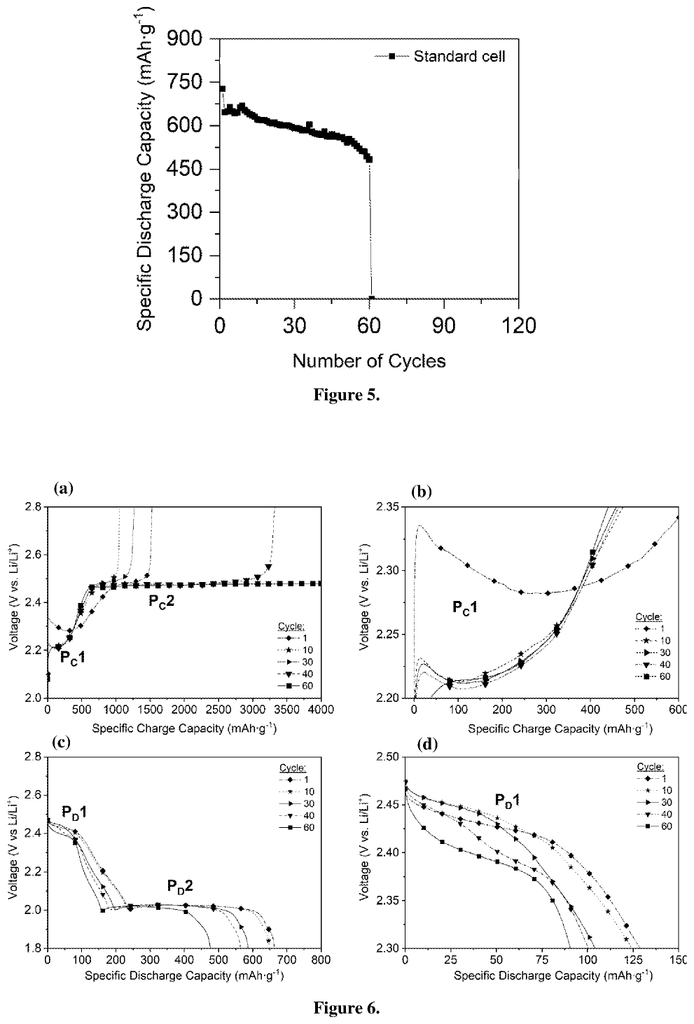

The performance of control cells in shown in FIGS. 5 and 6.

A drop in the voltage across the cell occurs from the end of the charge cycle to the beginning of the discharge cycle as a consequence of changing internal resistance. During the charging cycle, the electrolyte is polarised. This polarisation relaxes during the 5 min resting period which causes the voltage drop.

The charging overpotential observed in early cycles (FIG. 4(b), ˜0.1 V) is assigned to the formation of Li₂S. The size of the overpotential is due to the size and morphology of the insulating Li₂S. The decrease in overpotential in the latter cycles is likely due to the formation of smaller and more dispersed Li₂S. Mechanistically, literature suggests Li₂S oxidation (and sulfur reduction) requires solvation to avoid large overpotentials. As Li₂S is relatively insoluble in the ether solvents, small uniform deposits are the only way to avoid large overpotentials at the start of charging. The presence of HS—SiO₂ is believed to provide chemical nucleation sites for Li₂S crystallisation, as electrode morphology changes more active silica surface area is available for Li₂S deposition.

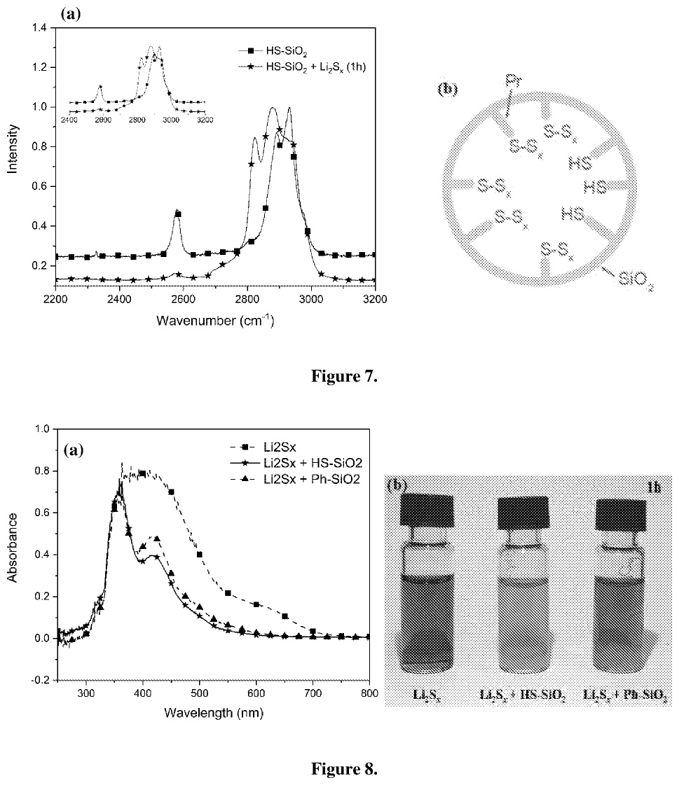

In comparison with control cells active sulfur retention is improved in HS—SiO₂ containing cells, alluding to greater localisation of polysulfides to the cathodic region. Raman data collected on HS—SiO₂ samples exposed to a Li₂Sₓ solution in DOL/TEGDME shows a marked decrease in the intensity of the S—H absorption band (˜2600 cm⁻¹) when compared with HS—SiO₂ samples exposed a blank DOL/TEGDME solvent mixture (without LiTFSI salt) (FIG. 7(b)). The band at ˜2700-3000 cm⁻¹ is attributed to C—H stretches from the alkyl chain linking the thiol group to the silica surface.

Testing of Control Cells with pH-SiO₂ Additive

The relative importance of morphology versus functionalisation in the control of polysulfide mobility in the Li—S cells was initially unclear. To probe the relative contributions of physical adsorption and chemical binding of polysulfides, UV-Vis spectra were collected on solutions of Li₂Sₓ before and after the addition of the HS—SiO₂. Ph-SiO₂ is not expected to bind chemically with nucleophillic polysulfide anions, and was chosen as the control. Ph-SiO₂ samples had a hollow spherical structure with a pore size of 10.1 nm, slightly smaller than that of HS—SiO₂ (10.8 nm), though sufficiently large enough to allow significant penetration by the polysulfides.

Both solutions exposed to HS—SiO₂ and Ph-SiO₂ show a decrease in absorption intensity (FIG. 8(a)) relative to the control solution, indicating capture of polysulfides. Interestingly, the Ph-SiO₂ exposed solution showed almost an equivalent intensity decrease, indicating a greater role of physical adsorption in polysulfide capture. The colours of the HS—SiO₂ and Ph-SiO₂ exposed solutions (FIG. 8(b)) are consistent with this decrease in the concentration of the unbound Li₂Sₓ in solution.

Polysulfide species have characteristic UV-Vis absorbances owing to the different levels of spatial delocalisation of molecular orbitals dependent on chain length and subsequent geometry. The control sample of Li₂Sₓ has absorbances at wavelengths 617, 560, 470, 450, 420 and 340 nm, corresponding respectively to S₃⁻, S₈²⁻, S₆²⁻, S₅²⁻, S₄²⁻ and S₃²⁻ species. However, disproportionation equilibria mean it is difficult to produce a sample containing a singular polysulfide species, peak absorbance wavelengths (340-500 nm) indicate S₆²⁻, S₅²⁻, S₄²⁻ and S₃²⁻ species the predominant constituents of Li₂Sₓ.

The functionalisation of the silicas suggests selectivity for the species capture: the S₃⁻, S₈²⁻, S₆²⁻, S₅²⁻ absorbance band decreased significantly with a minor decrease in intensity observed at 340 nm (assigned to S₃²⁻) for both functionalised silica samples. The S₄²⁻ absorbance (420 nm) is still present for both functionalised silica samples, with the HS—SiO₂ sample displaying a greater ability to remove S₄²⁻ than Ph-SiO₂. One explanation for these trends is that while the entry for the longer order polysulfides to the hollow spheres of the functionalised silica is relatively unhindered, interactions with the groups on the inside greatly decrease mobility inside the spheres. Shorter chain species are less susceptible to this and hence remain in the bulk solution, detectable by UV-Vis spectroscopy. The absence of S_{3.}⁻ is explained by shifting disproportionation equilibria in favour of S₆²⁻ production following its capture by x-SiO₂.

Overwhelmingly, the addition of HS—SiO₂ mitigated the diffusion of polysulfide anions. Increased capacity retention and columbic efficiency coupled with stable size of P_{C}2 suggest migration of polysulfide species is greatly reduced. Raman and UV-Vis studies of x-SiO₂ suggest a combination of physical adsorption and chemical binding effects. Polysulfide species are physically contained within the hollow silica spheres and bound via thiol functional groups within. This has the net effect of vastly reducing the mobility of polysulfide anions and their impact on the cycle stability of the cells.

Testing of Control Cells with Molecular Additive (DMAB)

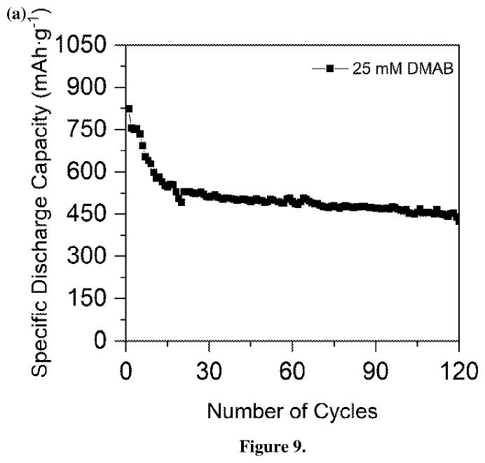

Cells containing 25 mM DMAB in the electrolyte showed initial rapid capacity fading followed by stabilisation (FIG. 9). With an initial specific discharge capacity of 824 mAh·g-1, a specific capacity of 498 mAh-g-1 after 18 cycles represented a 40% decrease. Rapid initial capacity fading is archetypal of high resistance solid electrode interface (SEI) formation, with electrolyte components reacting with the lithium metal anode to form a solid and largely insoluble layer. While this layer is permeable to positive lithium ions, the addition of DMAB likely formed a more resistive SEI that caused significant losses in capacity compared to the initial discharge.

### Example 2 Other Particle Structures

### A. Hollow SiO₂ Spheres (Unfunctionalised)

F127 (3.60 g) and K₂SO₄ (12.6 g) were dissolved in water (216 mL), the solution was cooled to 13.5° C. and stirred for 3 h. Tetramethoxysilane (TMOS) (10.6 mL) was then added and the mixture was stirred for 24 h at 13.5° C.

The resulting mixture was aged for 24 h in a Teflon-lined stainless-steel autoclave to give F127@SiO₂ (6.45 g). The resulting material was washed with water and dried at 60° C. The resulting material was refluxed in a solution of HCl (32% v/v, 1.5 mL) in ethanol (200 mL) for 24 h before being washed with excess ethanol and dried.

The material was characterised with TEM (not shown) which showed monodisperse hollow spheres with a diameter of ˜20 nm, Raman spectroscopy (not shown) demonstrated a lack of surface functionalisation and absence of the F127 templating agent in the final product, and BET surface area analysis (not shown) to show pore sizes of ˜2-10 nm.

The material was tested in sulfur cathodes with a mass loading of 5 wt % according to the general battery testing method.

### B. Solid SiO₂ Spheres (Thiol Functionalised)

MTS (5 mL) was added to surfactant solution of CTAB (4 mM) and stirred for 24 h before being filtered, washed with dilute HCl (20 mL) and dried at 60° C. to obtain a white powder.

The particles were characterised with TEM (not shown) to show 50-100 nm spheroid particles. Raman spectroscopy (not shown) was used to confirm thiol functionalisation.

The material was tested in sulfur cathodes with a mass loading of 5 wt % according to the general battery testing method.

C. Solid SiO₂ Spheres (Solid SiO₂ Nanospheres No Sulfur Functionalisation)

TMOS (5 mL) was added to surfactant solution of CTAB (4 mM) and stirred for 24 h before being filtered, washed with dilute HCl (20 mL) and dried at 60° C. to obtain a white powder.

The particles were characterised with TEM (not shown) to show 50-100 nm spheroid particles. Raman spectroscopy (not shown) was used to confirm a lack of thiol functionalisation.

The material was tested in sulfur cathodes with a mass loading of 5 wt % according to the general battery testing method.

### D. Mesoporous SiO₂ (Thiol-Functionalised)

Pluronic P123 (2.76 g) and K₂SO₄ (21.0 g) were dissolved in water (360 mL) and stirred for 3 h at 13.5° C. MTS (2.85 mL) was dissolved in mesitylene (6.95 g) and the mixture was added to the water solution. The resulting mixture was stirred for 3 h at 13.5° C. TMOS (17.6 mL) was added to the reaction which was then stirred for 24 h.

The resulting mixture was aged for 24 h in a Teflon-lined stainless-steel autoclave to give P123@SH—SiO₂ (12.4 g). The resulting material was washed with water and dried at 60° C. The resulting material was refluxed in a solution of HCl (32% v/v, 3 mL) in ethanol (400 mL) for 24 h before being washed with excess ethanol and dried.

The material was characterised with TEM (not shown) which showed mesoporous sheet networks with pores 20 nm in diameter, Raman spectroscopy (not shown) demonstrated thiol surface functionalisation and absence of the P123 templating agent in the final product and BET surface area analysis (not shown) to show pore sizes of 2-10 nm and internal cavities of ˜20 nm.

### E. Mesoporous SiO₂ (No Sulfur Functionalisation)

Pluronic P123 (2.76 g) and K₂SO₄ (21.0 g) were dissolved in water (360 mL) and the solution. After this TMOS (17.6 mL) was added to the reaction which was then stirred for 24 h at 13.5° C.

The resulting mixture was aged for 24 h in a Teflon-lined stainless-steel autoclave to give P123@SH—SiO₂ (12.3 g). The resulting material was washed with water and dried at 60° C. The resulting material was refluxed in a solution of HCl (32% v/v, 3 mL) in ethanol (400 mL) for 24 h before being washed with excess ethanol and dried.

The material was characterised with TEM (not shown) which showed mesoporous sheet networks with pores 20 nm in diameter, Raman spectroscopy (not shown) demonstrated a lack of sulfur functionalisation and absence of the P123 templating agent in the final product and BET surface area analysis (not shown) to show pore sizes of 2-10 nm and internal cavities of ˜20 nm.

The material was tested in sulfur cathodes with a mass loading of 5 wt % according to the general battery testing method.

F. Solid Xanthate-SiO₂ (Other Sulfur Group Functionalisation of SiO₂)

TMOS (5.0 mL) was added to surfactant solution of CTAB (4 mM) and stirred for 24 h before being filtered, washed with dilute HCl (20 mL) and dried at 60° C. to obtain a white powder.

The resulting particles (3.01 g) were stirred in carbon disulfide (10.0 mL) for 2 h before being dried in ambient conditions followed by in vacuo drying overnight.

The particles were characterised with TEM (not shown) to show 50-100 nm spheroid particles and networks of particles thereof. Raman (not shown) and IR spectroscopy were used to confirm a lack of sulfur functionalisation.

The material was tested in sulfur cathodes with a mass loading of 5 wt % according to the general method.

G. Hollow xanthate-SiO₂ (other sulfur group functionalisation of SiO₂)

Hollow silica nanospheres (2.03 g) synthesised according to Example 2 were stirred in conc. HCl (16% v/v, 45 mL) for 24 h before being washed with water and dried at 60° C. The resulting product was stirred in LiOH solution (2 M, 80 mL) for 24 h before being washed with water and dried. The resulting product was stirred in carbon disulfide (20.0 mL) before being dried at ambient conditions, followed by drying in vacuo at room temperature overnight.

The particles were characterised with TEM (not shown) to show 20 nm hollow spherical particles. Raman and infrared spectroscopy (not shown) was used to confirm xanthate surface functionalisation.

### H. Sulfur Functionalised TiO₂ (Sulfur Functionalised Transition Metal Oxide)

TiO₂ particles (P25) (0.60 g) were stirred in conc. HCl (16% v/v, 14 mL) for 24 h before being washed with water and dried at 60° C. The resulting product was stirred in LiOH solution (2 M, 20 mL) for 24 h before being washed with water and dried. The resulting product (1.44 g) was stirred in carbon disulfide (5 mL) before being dried at ambient conditions, followed by drying in vacuo at room temperature overnight to recover an off white solid.

The product was characterised with TEM (not shown), Raman spectroscopy and IR (not shown) was done to show a xanthate surface functionalisation.

I. Alkyl Linker Xanthate-SiO₂ (Sulfur Group Functionalisation of SiO₂ with a Linker Other than C₃ (Propyl))

Nanoparticulate SiO₂ (500 mg) was added to 1,8-octanediol (20 g) was dried in vacuo for 2 h before being heated at 150° C. for 24 h. The resulting mixture was washed with a hexane/ethanol mixture before being dried. The resulting powder (300 mg) was then stirred in a LiOH solution (2 M, 20 mL), washed with water and dried. The resulting product was stirred in carbon disulfide (5 mL) before being dried at ambient conditions, followed by drying in vacuo at room temperature overnight.

### J. Xanthate-Functionalised Carbon Nitride (Sulfur Group Functionalisation on Transition Metal Nitride)

Carbon nitride particles (3.0 g) were stirred in conc. HCl (32% v/v, 20 mL) for 24 h before being washed with water and dried at 60° C. The resulting product was stirred in LiOH solution (2 M, 20 mL) for 24 h before being washed with water and dried. The resulting product was stirred in carbon disulfide (5 mL) before being dried at ambient conditions, followed by drying in vacuo at room temperature overnight.

K. Phenyl Xanthate Functionalised SiO₂ (Sulfur Group Functionalisation on SiO₂ with a Linker Other than C₃ (Propyl))

Nanoparticulate SiO₂ (500 mg) was added to a solution of hydroquinone in water was refluxed (600 mg in 100 mL) for 24 h. The resulting mixture was washed with water. The resulting powder (300 mg) was then stirred in a LiOH solution (2 M, 20 mL), washed with water and dried. The resulting product was stirred in carbon disulfide (5 mL) before being dried at ambient conditions, followed by drying in vacuo at room temperature overnight.

Additive materials from the above examples A-F were used to make a sulfur cathode with a loading of 5 wt % wherein the remaining materials were a conductive additive (Super P carbon black, 25 wt %) and elemental sulfur (60 wt %).

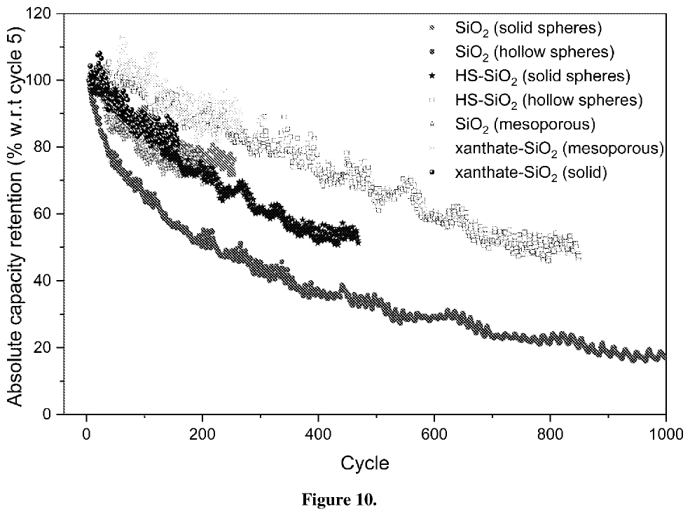

The materials were ground together and added to a solution of PVDF-HFP (10 wt %) in NMP (50 mL_{NMP}/g_{binder}) and stirred for at least 24 h. The resulting slurry was cast onto aluminium foil at various wet thicknesses (50 μm, 100 μm, 200 μm, 300 μm) and the electrodes were dried at 60° C. overnight before being cut and further dried in vacuo at room temperature overnight before testing. The result of these test can be seen in FIG. 10.

### L. Alternative Loadings

Hollow HS—SiO₂ nanospheres were used to make a sulfur cathode with a loading of 4 wt % wherein the remaining materials were a conductive additive (Ketjen black EC-300, 26 wt %) and elemental sulfur (60 wt %).

The materials were ground together and added to a solution of PVDF-HFP (10 wt %) in NMP (50 mL_{NMP}, g_{binder}) and stirred for at least 24 h. The resulting slurry was cast onto aluminium foil at various wet thicknesses (50 μm, 100 μm, 200 μm, 300 μm) and the electrodes were dried at 60° C. overnight before being cut and further dried in vacuo at room temperature overnight.

### M. Alternative Drying Procedure No. 1

A slurry was produced with a composition porous particle additive (HS—SiO₂ nanospheres, 5 wt %) binder (PVDF-HFP, 10 wt %), conductive additive (Super P carbon black, 25 wt %) and elemental sulfur (60 wt %) in NMP according to the above procedure. After coating the electrodes were dried at 150° C. for an extended period.

### N. Alternative Drying Procedure No. 2

Sulfur cathodes produced with a composition porous particle additive (HS—SiO₂ nanospheres, 5 wt %) binder (PVDF-HFP, 10 wt %), conductive additive (carbon nanotubes, 25 wt %) and elemental sulfur (60 wt %) were heated in a sealed autoclave at 150° C.

### Testing Notes

Where battery testing was conducted, all electrodes were used as the cathode in a half-cell assembled according to the general method in paragraphs [00108]-[00110] above.

Although the invention has been described with reference to specific examples, it will be appreciated by those skilled in the art that the invention may be embodied in many other forms in particular features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A cathode material for a lithium sulfur battery comprising:
a source of sulfur, and
a particle having a surface adapted to immobilise a polysulfide.

2. The cathode material of claim 1, wherein the surface adapted to immobilise a polysulfide comprises surface functionalisation with sulfur-containing functional groups, thereby to immobilise the polysulfide.

3. The cathode material of claim 2, wherein the particle comprises an internal surface, an external surface, or both.

4. The cathode material of claim 3, wherein the internal surface is functionalised with a plurality of sulfur-containing functional groups and the external surface is substantially free from sulfur-containing functional groups.

5. The cathode material of claim 3, wherein the external surface is functionalised with a plurality of sulfur-containing functional groups and the internal surface is substantially free from sulfur-containing functional groups.

6. The cathode material of claim 3, wherein the external surface and the internal surface are functionalised with a plurality of sulfur-containing functional groups.

7. The cathode material of any one of claims 2 to 6, wherein the sulfur-containing functional group is selected from the group consisting of thiol, thioketone, thial, thiocarboxylic acid, dithiocarboxylic acid, sulfonamide, sulfonate, thiosulfonate, sulfone, and xanthate.

8. The cathode material of any one of claims 2 to 7 wherein the sulfur-containing functional groups are covalently joined to the internal or external surface of the particle directly or are joined by a linker.

9. The cathode material of any one of claims 2 to 8, wherein the sulfur-containing functional groups are covalently joined to the internal or external surface of the particle by a linker and the linker is a linear or branched C₁ to C₃₂ alkyl chain, C₁ to C₃₂ alkenyl chain, or C₁ to C₃₂ alkaryl chain, wherein the linker is optionally substituted.

10. The cathode material of any of claims 1 to 9, wherein the particle is porous.

11. The cathode material of claim 10, wherein a pore volume of the porous particle is at least 0.3 cm³/g.

12. The cathode material of any one of claims 1 to 11, wherein a Brunauer-Emmett-Teller surface area of the porous particle is at least 70 m²/g.

13. The cathode material of claim 10 or 11, wherein an average pore diameter of the porous particle is between 0.1 nm-5 μm.

14. The cathode material of any one of claims 2 to 13, wherein the degree of functionalisation of the particle with the sulfur-containing functional groups is between 0.1 to 3 mmol/g.

15. The cathode material of any one of claims 1 to 14, wherein the diameter of the particle is between 5 nm-500 μm.

16. The cathode material of any one of claims 1 to 15, wherein the particle is substantially spherical and has an internal cavity.

17. The cathode material of claim 16, wherein the particle has a wall thickness of between about 1-500 nm and the diameter of the internal cavity is between about 1 nm-100 μm.

18. The cathode material of any one of claims 1 to 17, wherein the source of sulfur is selected from the group consisting of elemental sulfur, lithium (poly)sulfide, and a sulfur containing composite.

19. The cathode material of any one of claims 1 to 18, wherein the source of sulfur is encapsulated within the particle.

20. The cathode material of any one of claims 1 to 19, further comprising a binder.

21. The cathode material of claim 20, wherein the binder is selected from the group consisting of fluorinated polymers, optionally poly(vinylidene fluoride) (PVDF), poly(vinylidene fluoride)-co-hexafluoropropylene (PVDF-HFP) or polytetrafluoroethylene (PTFE), cellulose derivatives, optionally CMC, polyacrylic nitrides, polyacrylic acids, co-acrylic acids, styrene butadiene, and ionic polymers.

22. The cathode material of any one of claims 1 to 21, wherein the particle is composed of a non-conductive material and the cathode material further comprises a conductive material.

23. The cathode material of claim 22, wherein the particle is composed of silica, titania, zeolite, aluminosilicate, or aluminosilica.

24. The cathode material of claim 22 or claim 23, wherein the conductive material is selected from the group consisting of carbon black, carbon nanotubes, mesoporous carbon, graphene, graphite, expanded graphite, graphene oxides, activated carbons, glassy carbons, and diamond-like carbons.

25. The cathode material of any one of claims 22 to 24, wherein the amounts of the conductive material, the source of sulfur, a plurality of the particles, and optionally a binder sum to 100 wt. %, and the amount of conductive material is between about 3 to 70 wt. %, the amount of source of sulfur is between about 20 to 90 wt. %, the amount of particles is between about 1 to 70 wt. %, and the amount of binder, if optionally present, is between about 0.1 to 20 wt. %.

26. The cathode material of any one of claims 1 to 21, wherein the particle is composed of a conductive material.

27. The cathode material of claim 26, wherein the particle is composed of carbon, or transition metal oxides or nitrides, optionally vanadium, zirconium or titanium nitride.

28. The cathode material of claim 26 or claim 27, comprising a further conductive material.

29. The cathode material of claim 28, wherein the further conductive material is selected from the group consisting of carbon black, carbon nanotubes, mesoporous carbon, graphene, graphite, expanded graphite, graphene oxides, activated carbons, glassy carbons, and diamond-like carbons.

30. The cathode material of any one of claims 26 to 29, wherein the amounts of the source of sulfur, a plurality of the particles, optionally the further conductive material, and optionally a binder sum to 100 wt. %, and the amount of source of sulfur is between about 20 to 90 wt. %, the amount of particles is between about 1 to 70 wt. %, the amount of further conductive material, if optionally present, is between about 1 to 30 wt. %, and the amount of binder, if optionally present, is between about 0.1 to 20 wt. %.

31. A lithium sulfur battery comprising a cathode comprising the cathode material of any one of claims 1 to 30, an anode comprising a lithium source, and an electrolyte disposed between the cathode and the anode.

32. The lithium sulfur battery of claim 31, wherein the lithium source is lithium metal, lithiated silicon, or lithiated carbon.

33. The lithium battery of claim 31 or claim 32, wherein the battery has a Coulombic efficiency of at least 70% after 100 cycles.

34. The lithium battery of any one of claims 31 to 33, wherein the specific discharge capacity of the battery does not decrease by more 20% of its initial value after 100 cycles.

35. Use of a particle in the cathode of a lithium sulfur battery, wherein the particle has a surface adapted to immobilise a polysulfide.

36. The use of claim 35, wherein the surface adapted to immobilise a polysulfide comprises an internal surface, an external surface, or both, wherein the internal surface and/or the external surface is functionalised with a plurality of sulfur-containing functional groups.

37. A method of reducing capacity fading of a lithium sulfur battery, the battery comprising a cathode comprising a source of sulfur, an anode comprising a lithium source, and an electrolyte, the method comprising adding a particle to the cathode,
wherein the particle has an internal surface and an external surface, wherein the internal surface and/or external surface is functionalised with a plurality of sulfur-containing functional groups.

38. The use of claim 35 or claim 36, or the method of claim 37, wherein the particle is porous.
